(19) United States
(12) Patent Application Publication
(10) Pub. No.: US 2003/0049551 A1
(43) Pub. Date: Mar. 13, 2003

(54) Blue diode laser sensitive photoreceptor

(75) Inventors: Satish R. Parikh, Rochester, NY (US); Kathleen M. Carmichael, Williamson, NY (US); Edward F. Grabowski, Webster, NY (US); Andrew R. Melnyk, Rochester, NY (US); Liang-Bih Lin, Webster, NY (US); Andronique Ioannidis, Webster, NY (US); Dasarao K. Murti, Mississauga (CA); Harold F. Hammond, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 09/947,930

(22) Filed: Sep. 7, 2001

(51) Int. Cl. G03G 5/047

(52) U.S. Cl. 430/58.65; 430/58.75; 430/59.4

(57) ABSTRACT

An electrostatographic article including: a substrate; a charge generator layer overcoated on the substrate and which layer is sensitive to blue light; and a charge transport layer overcoated on the charge generator layer and which charge transport layer is transparent to blue light.

### REFERENCE TO COPENDING AND ISSUED PATENTS

Attention is directed to commonly owned and assigned, copending application U.S. Ser. No. 09/784,417 (D/A0423) filed Feb. 16, 2001, U.S. Ser. No. 09/570,286 (D/A0425), filed May 12, 2000, and U.S. Ser. No. 09/570,286 (D/A0425Q), filed May 12, 2000.

The disclosures of each the above mentioned copending applications are incorporated herein by reference in their entirety. The appropriate components and processes of these patents may be selected for the toners and processes of the present invention in embodiments thereof.

### BACKGROUND OF THE INVENTION

The present invention is generally directed to layered photoresponsive devices, and imaging apparatus and processes thereof. More specifically, the present invention relates to an improved layered photoresponsive device comprised generally of a transport layer and a photogenerating layer. The layered photoresponsive devices of the present invention are useful as imaging members in various electrostatographic imaging systems, including those systems wherein electrostatic latent images are formed on the imaging member. Additionally, the photoresponsive devices of the present invention can be selectively irradiated with blue light, for example, as generated by a known blue diode laser, to accomplish, for example, latent image formation by, for example, charged area development (CAD) or discharge area development (DAD) methodologies.

Numerous photoresponsive devices for electrostatographic imaging systems are known including selenium, selenium alloys, such as arsenic selenium alloys; layered inorganic photoresponsive, and layered organic devices. Examples of layered organic photoresponsive devices include those containing a charge transporting layer and a charge generating layer. Thus, for example, an illustrative layered organic photoresponsive device can be comprised of a conductive substrate, overcoated with a charge generator layer, which in turn is overcoated with a charge transport layer, and an optional overcoat layer overcoated on the charge transport layer. In a further “inverted” variation of this device, the charge transporter layer can be overcoated with the photogenerator layer or charge generator layer. Examples of generator layers that can be employed in these devices include, for example, charge generator materials such as selenium, cadmium sulfide, vanadyl phthalocyanine, x-metal free phthalocyanine, benzimidazole perylent (BZP), hydroxygallium phthalocyanine (HOGaPc), and trigonal selenium dispersed in binder resin, while examples of transport layers include dispersions of various diamines, reference for example, U.S. Pat. No. 4,265,990, the disclosure of which is incorporated herein by reference in its entirety.

There continues to be a need for improved photoresponsive devices, and improved imaging systems utilizing such devices. Additionally, there continues to be a need for photoresponsive devices of varying sensitivity, which devices are economical to prepare and retain their properties over extended periods of time. Furthermore there continues to be a need for photoresponsive devices that permit both normal and reverse copying of black and white as well as full color images, especially in high speed digital printing systems.

### PRIOR ART

In U.S. Pat. No. 4,410,616, to Griffiths, et al., issued Oct. 18, 1983, there is disclosed an improved ambi-polar photoresponsive device useful in imaging systems for the production of positive images, from either positive or negative originals, which device is comprised of: (a) supporting substrate, (b) a first photogenerating layer, (c) a charge transport layer, and (d) a second photogenerating layer, wherein the charge transport layer is comprised of a highly insulating organic resin having dissolved therein small molecules of an electrically active material of N,N′-diphenyl-N,N′-bis(“X substituted” phenyl)-[1,1,-biphenyl]-4,4′-diamine wherein X is selected from the group consisting of alkyl and halogen. There is also disclosed an example of a first photogenerator layer with a red light sensitive material such as a phthalocyanine, and a second photogenerator layer with a blue light sensitive material, such as amorphous selenium, wherein a red highlight color image can be obtained when the ambi-polar device is charged positively, see column 7, lines 28-39.

In U.S. Pat. No. 5,405,709, Apr. 11, 1995, Littman, et al., there is disclosed an internal junction organic electroluminescent device comprised of, in sequence, an anode, an organic electroluminescent medium, and a cathode, the organic electroluminescent medium further comprising a hole injecting and transporting zone contiguous with the anode and an electron injecting and transporting zone contiguous with the cathode, the electron injecting and transporting zone further comprising an electron injecting layer in contact with the cathode, characterized in that the portion of the organic electroluminescent medium that is interposed between the electron injecting layer and the hole injecting and transporting zone is capable of emitting white light in response to hole-electron recombination and comprises a fluorescent material and a mixed ligand aluminum chelate of the formula (R^{s}−Q)₂—Al—O—L where Q in each occurrence represents a substituted 8-quinolinolato ligand, R^{s} represents an 8-quinolinolato ring substituent chosen to block sterically the attachment of more than two substituted 8-quinolinolato ligands to the aluminum atoms, O—L is a phenolato ligand, and L is a hydrocarbon group that includes a phenyl moiety. The compound 1,1-bis (di-4-tolylaminophenyl) cyclohexane (TAPC) is mentioned as a useful aromatic tertiary amine.

In U.S. Pat. No. 4,999,809, issued Mar. 12, 1991, Schildkraut, et al., there is disclosed a photorefractive device comprised of a first and second electrodes for establishing a potential gradient between first and second spaced locations and, interposed between the first and second electrodes, intermediate means capable of producing in a readout beam of electromagnetic radiation an image pattern corresponding to that present in a spatially intersecting writing beam of electromagnetic radiation when a potential gradient is applied to the intermediate means by said first and second electrodes. The intermediate means consists of a photorefractive layer capable of internally storing the image pattern of the writing beam created by its interference with an intersecting reference beam of electromagnetic radiation, the photorefractive layer being comprised of a homogeneous organic photoconductor containing organic noncentrosymmetric molecular dipoles capable of imparting to the photorefractive layer a second order polarization susceptibility of greater than 10⁻⁹ esu. The compound 1,1-bis (di-4-tolylaminophenyl) cyclohexane (TAPC) is also mentioned as a hole transporting agent, reference Example I.

In U.S. Pat. No. 5,876,887, issued Mar. 2, 1999, to Chambers, et al., there is disclosed an electrophotographic imaging member with a support, and at least one photoconductive layer having from about 90% by weight to about 10% by weight of the photoconductive particles of a photosensitive substituted perylene pigment, and, correspondingly, from about 10% by weight to about 90% by weight of at least one other n-type photosensitive pigment that is sensitive to shorter wavelength light than is the perylene pigment.

The aforementioned references are incorporated in their entirety by reference herein.

In the devices, imaging apparatuses, and processes of the prior art, various significant problems exist. For example, many conventional photoreceptor devices containing certain hole transport molecules (HTM) such as N,N′-diphenyl-N,N′-bis(3-methyl phenyl)-(1,1′-biphenyl)-4,4′-diamine (TPD) in an overlying charge transport layer cannot be successfully irradiated with specialized light sources, such as blue light generated from an aluminum-gallium-indium-nitride (AlGaInN) diode laser which source produces wavelength emissions, for example, of about 400 nanometers. This is because the certain hole transport molecules effectively absorb light at wavelengths below about 420 nanometers and thus prevent incident light from reaching the underlying charge generator layer. The application of a blue light diode laser irradiation source to electrophotographic imaging systems could potentially offer a number of significant and economic advantages, such as higher image resolution, improved print quality, and lower energy consumption. These and other advantages are enabled with the articles, apparatuses, and processes of the present invention.

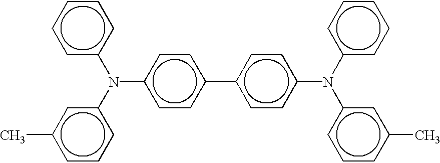

N,N′-diphenyl-N,N′-bis(3-methyl phenyl)-(1,1′-biphenyl)-4,4′-diamine (TPD)

There remains a need for articles, such as electroreceptors or photoreceptors, imaging apparatuses, and imaging processes which permits electrophotographic imaging systems to be efficiently and controllably irradiated with a blue light diode laser source.

### SUMMARY OF THE INVENTION

Embodiments of the present invention, include:

an electrostatographic article comprising:

a substrate;

a charge generator layer overcoated on the substrate and which layer is sensitive to blue light; and

a charge transport layer overcoated on the charge generator layer and which charge transport layer is transparent to blue light;

an electrophotographic article comprising: a blue light transparent transport layer which contains charge transport molecules of either or both 1,1-bis (di-4-tolylaminophenyl) cyclohexane (TAPC) and tritolylamine (TTA) and blue light sensitive generator layer which includes, for example, trigonal selenium;

an imaging process comprising:

irradiating the abovementioned imaging member with a diode laser at wavelength of from about 390 to about 410 nanometers;

developing the resulting latent image on the imaging member with a developer; and

transferring the resulting developed image to a receiver member; and

a printing machine comprising:

the abovementioned imaging member;

a diode laser light source adapted to produce wavelengths of from about 390 to about 410 nanometers to irradiate the imaging member and form a latent image on the imaging member;

a developer housing adapted to develop the latent image on the imaging member with a developer;

a receiver member adapted to receive the resulting developed image; and

an optional fixing member adapted to fix the resulting developed and transferred image to the receiver member.

These and other embodiments of the present invention are illustrated herein.

### BRIEF DESCRIPTION OF THE DRAWINGS

FIG. 1 illustrates the relative transparency of prototypical photoreceptor devices of the present invention measured as a function of percentage transmission versus wavelength of exposed light.

FIG. 2 illustrates the photo induced discharge curves (PIDC) measured at 670 and 400 nanometers of prototypical photoreceptor devices of the present invention having a generator layer that includes hydroxygallium phthalocyanine or bisbenzimidazo(2, 1-a-1′,2′-b)anthra(2,1,9-def:6,5,10-d′e′f′)diisoquinoline-6,11-dione and bisbenzimidazo(2,1-a:2′, 1′-a)anthra(2,1,9-def:6,5,10-d′e′f′)diisoquinoline-10,21-dione, (BZP)

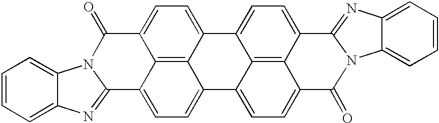

benzimidazole perylene-3,4,9,10-tetracarboxylic acid diimide (BZP)

as a function of image potential versus exposure energy.

FIG. 3 illustrates the photo induced discharge curve (PIDC) measured between 670 and 400 nanometers of prototypical photoreceptor devices of the present invention having a generator layer that includes hydroxygallium phthalocyanine (HOGaPc) as a function of image potential versus exposure energy.

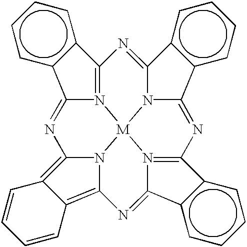

hydroxygallium phthalocyanine (HOGaPc); M=HOGa

FIG. 4 illustrates a cross section of an exemplary layered imaging article of the present invention.

FIGS. 5 and 6 show the chemical structural formulas of hole transport molecules 1,1-bis (di-4-tolylaminophenyl) (TAPC) tritolylamine and cyclohexane (TTA) respectively.

FIG. 7 shows the chemical structural formula of an exemplary coating resin for use in forming the coated layers of the present invention.

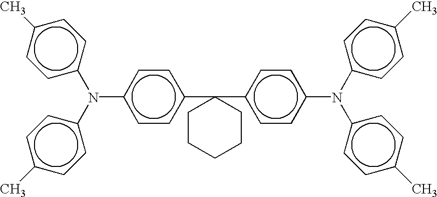

FIG. 5. 1,1-bis (di-4-tolylaminophenyl) cyclohexane (TAPC)

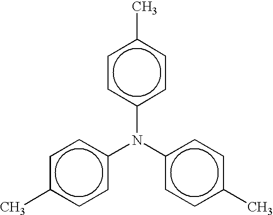

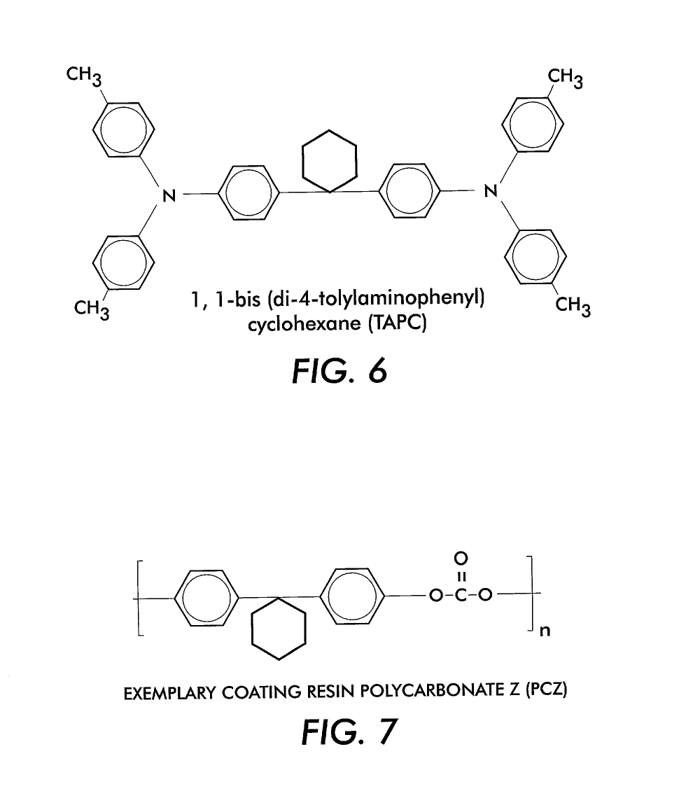

FIG. 6. tritolylamine (TTA)

### DETAILED DESCRIPTION OF THE INVENTION

The imaging member, imaging article, and processes thereof, of the present invention, may be used to create blue sensitive imaging devices that allow the use of 400 nanometer blue laser diodes as an exposure source. High resolution laser printers require pointwise exposure using the smallest possible diameter laser beam. The minimum size of a laser beam is governed by the limits imposed by diffraction from the optical elements in the laser delivery system. The minimum beam size at the photoreceptor surface for a given set of optical elements is directly proportional to the wavelength of the laser illumination. The beam size for a 400 nanometer laser diode would be approximately half that observed with the same hardware and a 780 nanometer laser diode.

An advantage of the present invention is that the article and processes thereof afford the following: higher resolution, higher print speed and a lower cost.

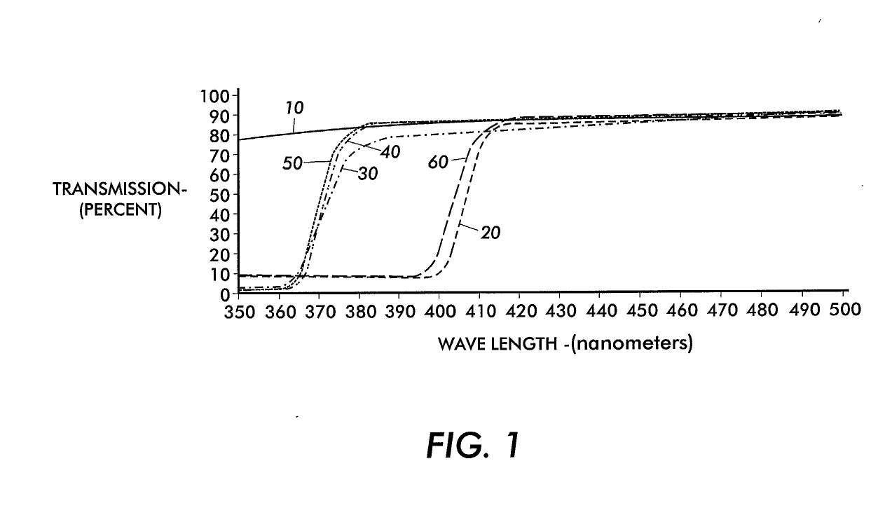

Referring to the Figures, FIG. 1 illustrates the relative transparency of prototypical photoreceptor transport layers of the present invention measured as a function of percentage transmission versus wavelength in nanometers of the incident or exposed light. Curve 10 represents a control or baseline measure of transmission for a 75 micrometer thick polymeric ethylene terephthalate (PET) substrate which is a typical substrate sued to fabricate photoreceptors. Curve 20 represents a measure of transmission for a device constructed with a 50/50 by weight mixture of m-TBD N,N′-diphenyl-N,N′-bis(3-methyl phenyl)-(1,1′-biphenyl)-4,4′-diamine (TPD) and MAKROLON® polycarbonate as a free standing film. Curve 30 represents a measure of transmission for a device constructed with a 50/50 by weight mixture of 1,1-bis (di-4-tolylaminophenyl) cyclohexane (TAPC) hole transport molecule and MAKROLON® polycarbonate as a free standing film. Curve 40 represents a measure of transmission for a device constructed with a 50/50 by weight mixture of tritolyamine TTA hole transport molecule and MAKROLON® polycarbonate free standing film. Curve 50 represents a measure of transmission for a device constructed with a 50/50 by weight mixture of 1,1-bis (di-4-tolylaminophenyl) cyclohexane (TAPC) hole transport molecule and MAKROLON® polycarbonate as an air dried free standing film. Curve 60 represents a measure of transmission for a device constructed with a layer containing a 1:1=TAPC: TPD mixture of hole transport molecules mixed 50/50 by weight with MAKROLON® polycarbonate as a free standing film.

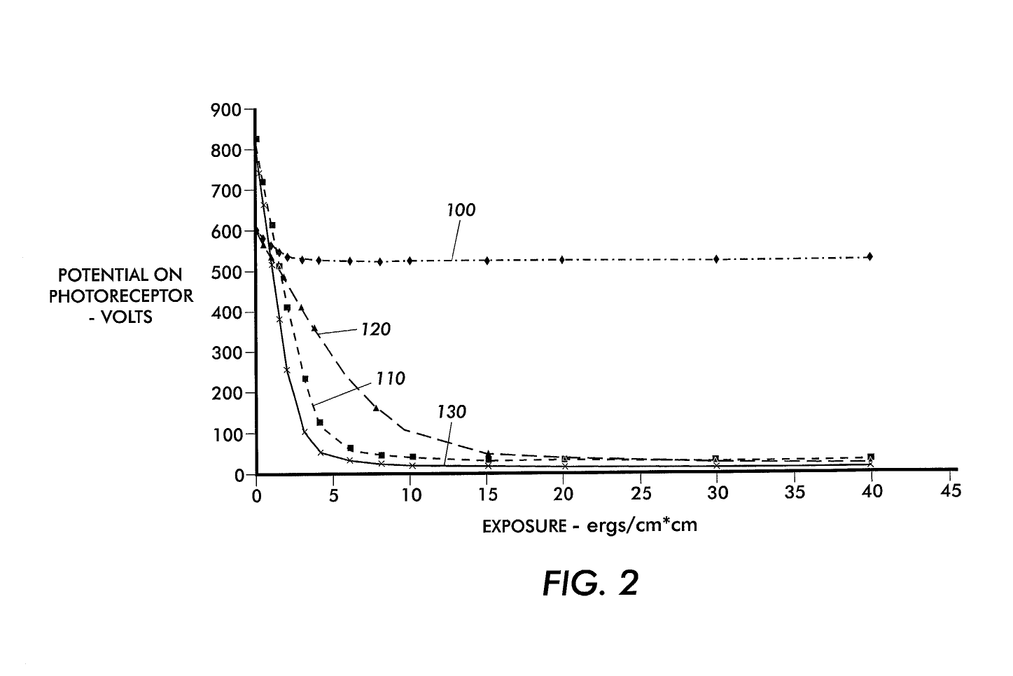

FIG. 2 illustrates the photo induced discharge curve (PIDC) measured at 400 nanometers of prototypical photoreceptor devices of the present invention having a 670 and background generator layer (BGL) that includes BZP as a function of image potential in volts versus exposure energy in ergs per centimeters squared. Curve 100 represents the PIDC for the BZP control device at 400 nm. Curve 110 represents the PIDC for the hydoxgallium phthalcyanine (HOGaPc). Curve 120 represents the PIDC for BZP at 400 nanometers. Curve 130 represents the PIDC for hydroxgallium phthalocyanine (HOGaPc) at 670 nanometers.

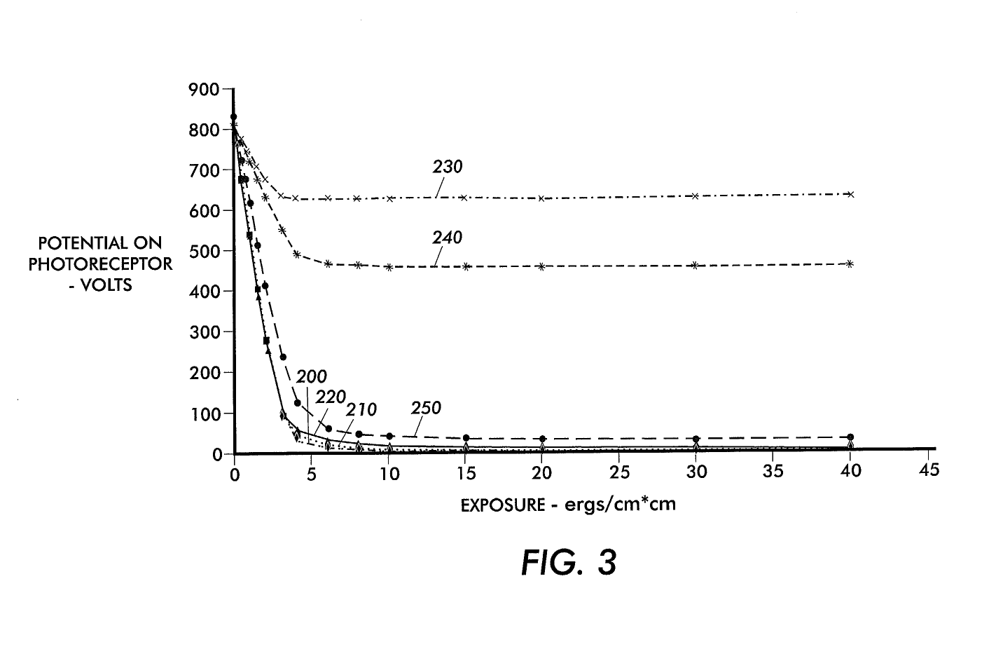

FIG. 3 illustrates the photon induced discharge curves (PIDC) measured at 670 and 400 nanometers of prototypical photoreceptor devices of the present invention having a background generator layer (BGL) that includes hydroxygallium phthalocyanine HOGaPc as a function of image potential in volts versus exposure energy in ergs per centimeters squared. Curve 200 represents the PIDC for the N,N′-diphenyl-N,N′-bis(3-methyl phenyl)-(1,1′-biphenyl)-4,4′-diamine (TPD) control device at 670 nm and curve 230 represents the PIDC for the same device at 400 nm. There is very little discharge at 400 nm as the TPD containing device absorbs at this wavelength. Curve 220 represents the PIDC at 670 nm for the device having a background generator layer (BGL) that includes HOGaPc and with 1,1-bis (di-4-tolylaminophenyl) cyclohexane (TAPC) as the hole transport molecule in the charge transport layer and appears to provide a PIDC with a comparable profile compared to curves 200 and 210. Curve 250 represents the PIDC of the TAPC device at 400 nm and shows significant improvement in discharge over the TPD control device in curve 230. Curve 210 represents the PIDC for the device having a background generator layer (BGL) that includes HOGaPc and with a 1:1 by weight mixture of 1,1-bis (di-4-tolylaminophenyl) cyclohexane (TAPC) and N,N′-diphenyl-N,N′-bis(3-methyl phenyl)-(1,1′-biphenyl)-4,4′-diamine (TPD) hole transport molecules in the charge transport layer at 670 nm and the PIDC is comparable to the control curve 200 and curve 220. Curve 240 represents the PIDC for the TPD/TAPC mixed device at 400NM. Note the intermediate discharge level between the pure TPD, curve 230, and pure TAPC, curve 250 at this same wavelength.

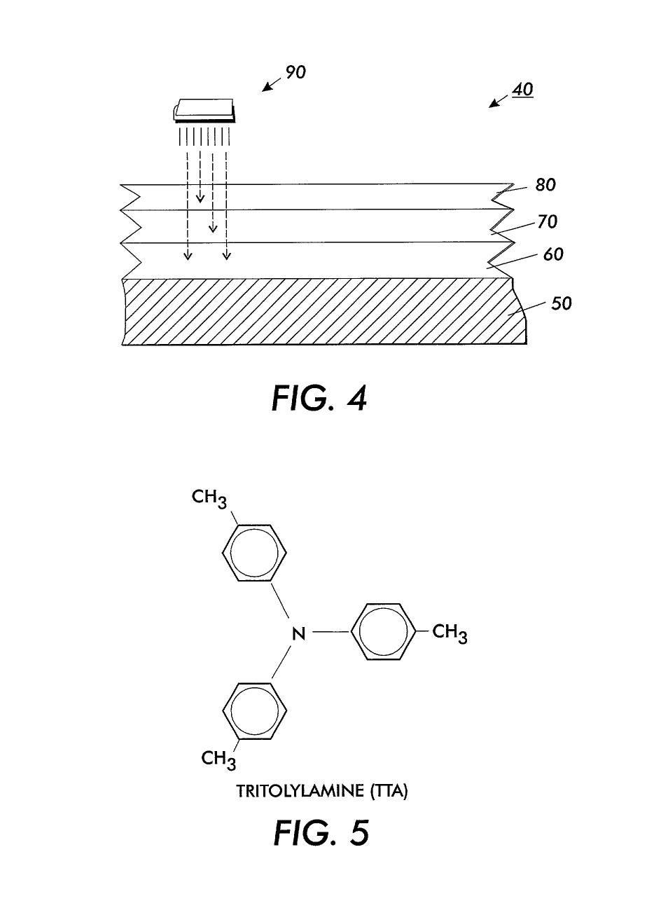

FIG. 4 illustrates a cross section of an exemplary layered imaging article 40 of the present invention including a substrate 50, a charge generator layer 60, a charge transport layer 70, and an optional overcoat layer 80, which article responds to as indicated in the above mentioned figures and as described herein when exposed to a suitable radiation source 90.

FIGS. 5 and 6 show the chemical structural formulas of 1,1-bis (di-4-tolylaminophenyl) tritolyamine and cyclohexane (TAPC) and (TTA), respectively.

FIG. 7 shows the chemical structural formula of an exemplary coating resin polycarbonate Z (PCZ), for use in forming the coated layers of the present invention.

The present invention is particularly desirable for electrophotographic imaging layers which comprise two electrically operative layers, a charge generating layer and a charge transport layer.

### The Substrate

The substrate may be opaque or substantially transparent and may comprise numerous suitable materials having the required mechanical properties. The substrate may further be provided with an electrically conductive surface. Accordingly, the substrate may comprise a layer of an electrically non-conductive or conductive material such as an inorganic or organic composition. As electrically non-conducting materials, there may be employed various resins known for this purpose including polyesters, polycarbonates, polyamides, polyurethanes, and the like. The electrically insulating or conductive substrate may be flexible, semi-rigid, or rigid, and may have any number of different configurations such as, for example, a sheet, a scroll, an endless flexible belt, a cylinder, and the like. The substrate may be in the form of an endless flexible belt which comprises a commercially available biaxially oriented polyester known as MYLAR™, MELINEX™, and KALADEX® available from E. I. du Pont de Nemours & Co.

The thickness of the substrate layer depends on numerous factors, including mechanical performance and economic considerations. The thickness of this layer may range from about 65 micrometers to about 150 micrometers, and preferably from about 75 micrometers to about 125 micrometers for optimum flexibility and minimum induced surface bending stress when cycled around small diameter rollers, for example, 19 millimeter diameter rollers. The substrate for a flexible belt may be of substantial thickness, for example, over 200 micrometers, or of minimum thickness, for example less than 50 micrometers, provided there are no adverse effects on the final photoconductive device. The surface of the substrate layer is preferably cleaned prior to coating to promote greater adhesion of the deposited coating composition. Cleaning may be effected by, for example, exposing the surface of the substrate layer to plasma discharge, ion bombardment, and the like methods.

### The Electrically Conductive Ground Plane

The electrically conductive ground plane may be an electrically conductive metal layer which may be formed, for example, on the coating article or substrate by any suitable coating technique, such as a vacuum depositing technique. Typical metals include aluminum, zirconium, niobium, tantalum, vanadium, hafnium, titanium, nickel, stainless steel, chromium, tungsten, molybdenum, and the like, and mixtures thereof. The conductive layer may vary in thickness over substantially wide ranges depending on the optical transparency and flexibility desired for the electrophotoconductive member. Accordingly, for a flexible photoresponsive imaging device, the thickness of the conductive layer may be from about 20 Angstroms to about 750 Angstroms, and more preferably from about 50 Angstroms to about 200 Angstroms for an optimum combination of electrical conductivity, flexibility and light transmission. Regardless of the technique employed to form the metal layer, a thin layer of metal oxide may form on the outer surface of most metals upon exposure to air. Thus, when other layers overlying the metal layer are characterized as “contiguous” layers, it is intended that these overlying contiguous layers may, in fact, contact a thin metal oxide layer that has formed on the outer surface of the oxidizable metal layer. Generally, for rear erase exposure, a conductive layer light transparency of at least about 15 percent is desirable. The conductive layer need not be limited to metals. Other examples of conductive layers may be combinations of materials such as conductive indium tin oxide as a transparent layer for light having a wavelength between about 4,000 Angstroms and about 9,000 Angstroms or a conductive carbon black dispersed in a plastic binder as an opaque conductive layer.

### The Blocking Layer

After deposition of the electrically conductive ground plane layer, the blocking layer may be applied thereto. Electron blocking layers for positively charged photoreceptors allow holes from the imaging surface of the photoreceptor to migrate toward the conductive layer. For negatively charged photoreceptors, any suitable hole blocking layer capable of forming a barrier to prevent hole injection from the conductive layer to the opposite photoconductive layer may be utilized. The hole blocking layer may include polymers such as polyvinylbutyral, epoxy resins, polyesters, polysiloxanes, polyamides, polyurethanes and the like, or may be nitrogen containing siloxanes or nitrogen containing titanium compounds such as trimethoxysilyl propylene diamine, hydrolyzed trimethoxysilyl propyl ethylene diamine, N-beta-(aminoethyl) gamma-amino-propyl trimethoxy silane, isopropyl 4-aminobenzene sulfonyl, di(dodecylbenzene sulfonyl) titanate, isopropyl di(4-aminobenzoyl)isostearoyl titanate, isopropyl tri(N-ethylamino-ethylamino)titanate, isopropyl trianthranil titanate, isopropyl tri(N,N-dimethyl-ethylamino)titanate, titanium-4-amino benzene sulfonate oxyacetate, titanium 4-aminobenzoate isostearate oxyacetate, [H₂N(CH₂)₄]CH₃Si(OCH₃)₂, gamma-aminobutyl) methyl diethoxysilane, and [H₂N(CH₂)₃]CH₃Si(OCH₃)₂, (gamma-aminopropyl)-methyl diethoxysilane, as disclosed in U.S. Pat. Nos. 4,338,387, 4,286,033 and 4,291,110. Other suitable hole blocking layer polymer compositions are also described in U.S. Pat. No. 5,244,762. These include vinyl hydroxyl ester and vinyl hydroxy amide polymers wherein the hydroxyl groups have been partially modified to benzoate and acetate esters which modified polymers are then blended with other unmodified vinyl hydroxy ester and amide unmodified polymers. An example of such a blend is a 30 mole percent benzoate ester of poly (2-hydroxyethyl methacrylate) blended with the parent polymer poly (2-hydroxyethyl methacrylate). Still other suitable hole blocking layer polymer compositions are described in U.S. Pat. No. 4,988,597. These include polymers containing an alkyl acrylamidoglycolate alkyl ether repeat unit. An example of such an alkyl acrylamidoglycolate alkyl ether containing polymer is the copolymer poly(methyl acrylamidoglycolate methyl ether-co-2-hydroxyethyl methacrylate). The disclosures of the U.S. Patents are incorporated herein by reference in their entirety.

The blocking layer is continuous and may have a thickness of less than about 10 micrometers because greater thicknesses may lead to undesirably high residual voltage. A hole blocking layer of between about 0.005 micrometer and about 1.5 micrometers is preferred because charge neutralization after the exposure step is facilitated and optimum electrical performance is achieved. The blocking layer may be applied by any suitable conventional technique such as spraying, dip coating, draw bar coating, gravure coating, silk screening, air knife coating, reverse roll coating, vacuum deposition, chemical treatment and the like. For convenience in obtaining thin layers, the blocking layer is preferably applied in the form of a dilute solution, with the solvent being removed after deposition of the coating by conventional techniques such as by vacuum, heating and the like. Generally, a weight ratio of blocking layer material and solvent of between about 0.05:100 to about 5:100 is satisfactory for spray coating.

### The Adhesive Layer

Intermediate layers between the blocking layer and the adjacent charge generating or photogenerating layer may be desired to promote adhesion. For example, the adhesive layer may be employed. If such layers are utilized, they preferably have a dry thickness between about 0.001 micrometer to about 0.2 micrometer. Typical adhesive layers include film-forming polymers such as polyester, du Pont 49,000 resin, available from E. I. du Pont de Nemours & Co., VITEL-PE100™, available from Goodyear Rubber & Tire Co., polyvinylbutyral, polyvinylpyrrolidone, polyurethane, polymethyl methacrylate, and the like materials.

### The Imaging Layer(s)

The photoconductive layer may comprise any suitable photoconductive material well known in the art. Thus, the photoconductive layer may comprise, for example, a single layer of a homogeneous photoconductive material or photoconductive particles dispersed in a binder, or multiple layers such as a charge generating overcoated with a charge transport layer. The photoconductive layer may contain homogeneous, heterogeneous, inorganic or organic compositions. One example of an electrophotographic imaging layer containing a heterogeneous composition is described in U.S. Pat. No. 3,121,006, the disclosure of which is incorporated herein by reference in its entirety, wherein finely divided particles of a photoconductive inorganic compound are dispersed in an electrically insulating organic resin binder. Other well known electrophotographic imaging layers include amorphous selenium, halogen doped amorphous selenium, amorphous selenium alloys including selenium-arsenic, selenium-tellurium, selenium-arsenic-antimony, and halogen doped selenium alloys, cadmium sulfide and the like. Generally, these inorganic photoconductive materials are deposited as a relatively homogeneous layer.

Any suitable charge generating or photogenerating material may be employed as one of the two electrically operative layers in the multi-layer photoconductor embodiment of this invention. Typical charge generating materials include metal free phthalocyanine described in U.S. Pat. No. 3,357,989, metal phthalocyanines such as copper phthalocyanine, vanadyl phthalocyanine, selenium containing materials such as trigonal selenium, bisazo compounds, quinacridones, substituted 2,4-diamino-triazines disclosed in U.S. Pat. No. 3,442,781, and polynuclear aromatic quinones available from Allied Chemical Corporation under the tradename Indofast Double Scarlet, Indofast Violet Lake B, Indofast Brilliant Scarlet and Indofast Orange. Other examples of charge generating layers are disclosed in U.S. Pat. Nos. 4,265,990, 4,233,384, 4,471,041, 4,489,143, 4,507,480, 4,306,008, 4,299,897, 4,232,102, 4,233,383, 4,415,639 and 4,439,507, the disclosures of which are incorporated herein by reference in their entirety.

Any suitable inactive resin binder material may be employed in the charge generating layer. Typical organic resinous binders include polycarbonates, acrylate polymers, methacrylate polymers, vinyl polymers, cellulose polymers, polyesters, polysiloxanes, polyamides, polyurethanes, epoxies, polyvinylacetals, and the like. Many organic resinous binders are disclosed, for example, in U.S. Pat. Nos. 3,121,006 and 4,439,507, the disclosures of which are totally incorporated herein by reference. Organic resinous polymers may be block, random or alternating copolymers. The photogenerating composition or pigment can be present in the resinous binder composition in various amounts. When using an electrically inactive or insulating resin, it is preferred that there be high levels of particle-to-particle contact between the photoconductive particle population. This condition can be achieved, for example, with the photoconductive material present, for example, in an amount of at least about 15 percent by volume of the binder layer with no limit on the maximum amount of photoconductor in the binder layer. If the matrix or binder comprises an active material, for example, poly-N-vinylcarbazole, the photoconductive material need only to comprise, for example, about 1 percent or less by volume of the binder layer with no limitation on the maximum amount of photoconductor in the binder layer. Generally for charge generator layers containing an electrically active matrix or binder such as poly-N-vinyl carbazole or phenoxy-poly(hydroxyether), from about 5 percent by volume to about 60 percent by volume of the photogenerating pigment is dispersed in about 40 percent by volume to about 95 percent by volume of binder, and preferably from about 7 percent to about 30 percent by volume of the photogenerating pigment is dispersed in from about 70 percent by volume to about 93 percent by volume of the binder The specific proportions selected also depends to some extent on the thickness of the generating layer.

The thickness of the photogenerating binder layer is not particularly critical. Layer thicknesses from about 0.05 micrometer to about 40.0 micrometers may be satisfactory. The photogenerating binder layer containing photoconductive compositions and/or pigments, and the resinous binder material preferably ranges in thickness of from about 0.1 micrometer to about 5.0 micrometers, and has an optimum thickness of from about 0.3 micrometer to about 3 micrometers for best light absorption and improved dark decay stability and mechanical properties.

Other typical photoconductive layers include amorphous or alloys of selenium such as selenium-arsenic, selenium-tellurium-arsenic, selenium-tellurium, and the like.

The active charge transport layer may comprise any suitable transparent organic polymer or non-polymeric material capable of supporting the injection of photo-generated holes and electrons from the charge generating layer and allowing the transport of these holes or electrons through the organic layer to selectively discharge the surface charge. The active charge transport layer not only serves to transport holes or electrons, but also protects the photoconductive layer from abrasion or chemical attack and therefore extends the operating life of the photoreceptor imaging member. The charge transport layer should exhibit negligible, if any, discharge when exposed to a wavelength of light useful in xerography, for example, 4,000 Angstroms to 8,000 Angstroms. Therefore, the charge transport layer is substantially transparent to radiation in a region in which the photoconductor is to be used. Thus, the active charge transport layer is a substantially non-photoconductive material which supports the injection of photogenerated holes or electrons from the generating layer. The active transport layer is normally transparent when exposure is effected through the active layer to ensure that most of the incident radiation is utilized by the underlying charge generating layer for efficient photogeneration. The charge transport layer in conjunction with the generating layer is a material which is an insulator to the extent that an electrostatic charge placed on the transport layer is not conductive in the absence of illumination, that is, does not discharge at a rate sufficient to prevent the formation and retention of an electrostatic latent image thereon.

An especially preferred transport layer employed in the electrically operative layer in the photoconductor embodiment of this invention comprises from about 25 to about 75 percent by weight of at least one charge transporting aromatic amine compound, and about 75 to about 25 percent by weight of a polymeric film forming resin in which the aromatic amine is soluble. Examples of charge transporting aromatic amines for charge transport layer(s) capable of supporting the injection of photogenerated holes of a charge generating layer and transporting the holes through the charge transport layer include 1,1-bis (di-4-tolylaminophenyl) cyclohexane (TAPC), and tritolyamine (TTA).

Any polymer which forms a solid solution with the hole transport molecule (HTM) is a suitable polymer material for use in forming a hole transport layer in a photoreceptor device. Any solvent which dissolves both the polymer and the HTM are suitable for use in fabricating photoreceptor devices of the present invention. Any suitable inactive resin binder soluble in methylene chloride or other suitable solvent may be employed. Typical inactive resin binders soluble in methylene chloride include polycarbonate resin, polyvinylcarbazole, polyester, polyarylate, polystyrene, polyacrylate, polyether, polysulfone, and the like. Molecular weights can vary from about 20,000 to about 1,500,000.

The preferred electrically inactive resin materials are polycarbonate resins have a molecular weight from about 20,000 to about 100,000, more preferably from about 50,000 to about 100,000. The materials most preferred as the electrically inactive resin material is poly(4,4′-dipropylidene-diphenylene carbonate) with a molecular weight of from about 35,000 to about 40,000, available as LEXAN 145™ from General Electric Company; poly(4,4′-isopropylidene-diphenylene carbonate) with a molecular weight of from about 40,000 to about 45,000, available as LEXAN 141™ from the General Electric Company; a polycarbonate resin having a molecular weight of from about 50,000 to about 100,000, available as MAKROLON™ from Farbenfabricken Bayer A. G., a polycarbonate resin having a molecular weight of from about 20,000 to about 50,000 available as MERLON™ from Mobay Chemical Company and poly(4,4′-diphenyl-1,1-cyclohexane carbonate). Methylene chloride solvent is a particularly desirable component of the charge transport layer coating mixture for adequate dissolving of all the components and for its low boiling point. However, the type of solvent selected depends on the specific resin binder utilized.

Any suitable and conventional technique may be utilized to apply the charge transport layer and the charge generating layer. Typical application techniques include spraying, dip coating, roll coating, wire wound rod coating, and the like. Drying of the deposited coating may be effected by any suitable conventional technique such as oven drying, infra-red radiation drying, air drying and the like. Generally, the thickness of the transport layer is between about 5 micrometers to about 100 micrometers, but thicknesses outside this range can also be used. In general, the ratio of the thickness of the charge transport layer to the charge generating layer is preferably maintained from about 2:1 to 200:1 and in some instances as great as 400:1.

The invention will further be illustrated in the following non limiting Example, it being understood that this Example is intended to be illustrative only and that the invention is not intended to be limited to the materials, conditions, process parameters, and the like, recited herein. Parts and percentages are by weight unless otherwise indicated.

### COMPARATIVE EXAMPLE I

A N,N′-diphenyl-N,N′-bis(3-methyl phenyl)-(1,1′-biphenyl)-4,4′-diamine (TPD) containing charge transport layer was formed on a hydroxygallium phthalocyanine (HOGaPc) containing charge generating layer device. The photo induced discharge curves (PIDC) for were measured at 670 and 400 nanometers and are shown in FIG. 3.

### Example II

A 1,1-bis (di-4-tolylaminophenyl) cyclohexane (TAPC) shown in FIG. 5 containing charge transport layer was formed on both a BZP containing charge generating layer and a hydroxygallium phthalocyanine(HOGaPc) containing charge generating layer. The photoinduced discharge curves (PIDC) for the BZP and the HOGaPc devices were measured at 670 and 400 nanometers and are shown in FIG. 2. The hydroxygallium phthalocyanine device is discharged by both 670 nanometer and 400 nanometer light demonstrating that this device transmits 400 nanometer illumination to the generator layer. The BZP device discharges at 670 nanometers but does not discharge at 400 nanometers as the BZP pigment is not sensitive to 400 nanometer light. This demonstrates the need for a blue sensitive generation layer.

### Example III

An N,N′-diphenyl-N,N′-bis(3-methyl phenyl)-(1,1′-biphenyl)-4,4′-diamine TPD:TAPC (1:1) containing charge transport layer was formed on a hydroxygallium phthalocyanine(HOGaPc) containing charge generating layer. The photoinduced discharge curves (PIDC) for the BZP and the HOGaPc devices were measured at 670 and 400 nanometers and are shown in FIG. 3.

### Example IV

Photo-Transparency at 400 Nanometers

To assess the photo-transparency or photo-transmission of potential HTMs, four solutions were prepared with each solution containing a mixture of 50 weight percent of a HTM or mixture of two or more HTMs and 50 weight percent MAKROLON® 5705 polycarbonate together as 15 weight percent solids in methylene chloride. The four HTM or HTM combinations selected for analysis were: tritolyamine TTA; 1,1-bis (di-4-tolylaminophenyl) cyclohexane (TAPC); TAPC:TPD=1:1; and N,N′-diphenyl-N,N′-bis(3-methyl phenyl)-(1,1′-biphenyl)-4,4′-diamine TPD. The solutions were coated to provide a film layer of 25 micrometers dry thickness on MYLAR® then dried at 125° C. for one minute. The films were removed from the MYLAR® substrate and the percent transmission was measured for the resulting free standing films and the results are illustrated graphically in FIG. 1. Both tritolyamine TTA and 1,1-bis (di-4-tolylaminophenyl) cyclohexane (TAPC) transmit at 400 nanometers.

Other modifications of the present invention may occur to one of ordinary skill in the art based upon a review of the present application and these modifications, including equivalents thereof, substantial equivalents, similar equivalents, and the like, are intended to be included within the scope of the present invention.

What is claimed is:

1. An electrostatographic article comprising:
a substrate;
a charge generator layer overcoated on the substrate and which layer is sensitive to blue light; and
a charge transport layer overcoated on the charge generator layer and which charge transport layer is transparent to blue light.

1a. An article in accordance with claim 1, wherein the charge generator comprises metal free phthalocyanine, copper phthalocyanine, vanadyl phthalocyanine, hydroxygallium phthalocyanine, trigonal selenium, bisazo compounds, quinacridones substituted 2,4-diamino-triazines and polynuclear aromatic quinones.

1b. An article in accordance with claim 1, wherein the charge transport layer comprises a non-photoconductive material which supports the injection of photogenerated holes or electrons from the generating layer.

2. An article in accordance with claim 1, wherein the charge transport layer contains the charge transport molecule tritolyamine (TTA) in an amount of from about 10 to about 70 weight percent based on the total weight of the transport layer.

3. An article in accordance with claim 1, wherein the charge transport layer contains the charge transport 1,1-bis (di-4-tolylaminophenyl) cyclohexane (TAPC) in an amount of from about 10 to about 70 weight percent based on the total weight of the transport layer.

4. An article in accordance with claim 1, wherein the charge transport layer contains a mixture of charge transport molecules 1,1-bis (di-4-tolylaminophenyl) cyclohexane (TAPC) and tritolyamine (TTA) in a relative weight ratio of from about 0.1:1 to about 1:0.1 and in a total amount of from about 10 to about 70 weight percent based on the total weight of the transport layer.

5. An article in accordance with claim 1, wherein the charge transport layer contains a mixture of charge transport molecules 1,1-bis (di-4-tolylaminophenyl) cyclohexane (TAPC) and TPD in a relative weight ratio of from about 0.1:1 to about 1:0.1 and in a total amount of from about 10 to about 70 weight percent based on the total weight of the transport layer.

6. An article in accordance with claim 1, wherein the charge generator layer contains a binder resin in an amount of from about 50 to about 99 weight percent based on the total weight of the charge generator layer.

7. An article in accordance with claim 1, wherein the charge generator layer contains a charge generator material of trigonal selenium (“t-Se”) in an amount of from about 1 to about 25 weight percent based on the total weight of the charge generator layer.

8. An article in accordance with claim 1, wherein the charge transport layer includes a binder resin.

9. An article in accordance with claim 8, wherein the charge transport layer binder resin is a polyester, a polycarbonate, a polyvinylbutaryl, a polyethercarbonate, an aryl amine polymer, as tyrene copolymer in an amount of from about 30 to about 90 weight percent based on the total weight of the transport layer.

10. An article in accordance with claim 1, further comprising an overcoat layer which overcoat layer is transparent to blue light of from about 390 to about 430 nanometers.

11. An article in accordance with claim 1, wherein the charge generator layer comprises metal free phthalocyanine, copper phthalocyanine, vanadyl phthalocyanine, hydroxygallium phthalocyanine, trigonal selenium, bisazo compounds, quinacridones substituted 2,4-diamino-triazines and polynuclear aromatic quinones.

12. An article in accordance with claim 1, wherein the charge generator layer comprises trigonal selenium, or hydroxygallium phthalocyanine.

13 An article in accordance with claim 1, wherein the charge generator layer is hydroxygallium phthalocyanine.

14. An article in accordance with claim 1, wherein the charge generator layer has a film thickness of from 0.01 to 5 microns and the charge transport layer has a film thickness of from 5 to 50 microns.

15. An electrophotographic article comprising: a blue light transparent transport layer which contains charge transport molecules of 1,1-bis (di-4-tolylaminophenyl) cyclohexane (TAPC), tritolyamine (TTA) or mixtures thereof and blue light sensitive generator layer which contains trigonal selenium.

16. An imaging process comprising:
irradiating the imaging member of claim 14 with a diode laser at wavelength of from about 390 to about 410 nanometers;
developing the resulting latent image on the imaging member with a developer; and
transferring the resulting developed image to a receiver member.

17. A process in accordance with claim 15, wherein high resolution images are formed and printing

18. A printing machine comprising:
an imaging member in accordance with claim 14;
a diode laser light source adapted to produce wavelengths of from about 390 to about 410 nanometers to irradiate the imaging member and form a latent image on the imaging member;
a developer housing adapted to develop the latent image on the imaging member with a developer;
a receiver member adapted to receive the resulting developed image; and
an optional fixing member adapted to fix the resulting developed and transferred image to the receiver member.

19. A printing machine in accordance with claim 17, wherein charge generator layer of the imaging member and has an actinic photosensitivity in the range of from about 395 to about 405 nanometers.

20. A photoconductive imaging member comprising
a supporting substrate,
an optional hole blocking layer,
an optional adhesive layer,
a charge transport layer,
a charge generating layer, and
an optional charge trapping layer.

21. An article according to claim 1, wherein the charge generating layer comprises photogenerating pigments.

22. An article according to claim 1, wherein the photogenerating pigments comprise selenium, cadmium sulfide, vanadyl phthalocyanine, x-metal free phthalocyanine, benzimidazole perylent (BZP), hydroxygallium phthalocyanine (HOGaPc), and trigonal selenium dispersed in binder resin.
